(19) United States
(12) Patent Application Publication
(10) Pub. No.: US 2019/0325567 A1
(43) Pub. Date: Oct. 24, 2019

(54) DYNAMIC IMAGE MODIFICATION BASED ON TONAL PROFILE

(71) Applicant: Microsoft Technology Licensing, LLC, Redmond, WA (US)

(72) Inventor: Alan Murray JONES, Duvall, WA (US)

(21) Appl. No.: 15/956,332

(22) Filed: Apr. 18, 2018

(51) Int. Cl. G06T 5/00; G06T 5/40; G06N 3/04; G06N 3/08; G06N 5/04; G06N 99/00; G06K 9/62

(52) U.S. Cl. CPC G06T 5/009; G06T 5/40; G06N 3/04; G06K 9/6267; G06N 5/046; G06N 99/005; G06N 3/08

(57) ABSTRACT

A method for dynamically tailoring on image operation based on tonal profile features of an input image includes a step of identifying tonal profile features of the input image; determining a transfer function for performing the image operation, the determined transfer function based on the tonal profile features and transfer function parameters determined from a set of training images subjected to the image operation; and performing the image operation according to the determined transfer function.

### BACKGROUND

Image manipulation is commonly performed to adapt digital images and digital video streams for presentation on different display platforms. For example, different display platforms may offer different resolutions and/or varying levels of contrast between the darkest and lightest pixels. To satisfy industry demands pertaining to image adaptability and viewing platform versatility, these types of image manipulations are sometimes automated by static pixel conversions. For example, a tone-mapping function may be utilized to map each instance of a particular pixel color to another particular color without regard to the contents of the particular image that is being operated on. This can sometimes lead to a loss of detail in image shadows or highlights or a resulting image that is otherwise poorly balanced after the image manipulation is performed.

### SUMMARY

According to one implementation, a method for dynamically tailoring an image operation based on tonal profile features of an input image includes identifying tonal profile features of the input image and determining a transfer function for performing the image operation. The determined transfer function is based on the tonal profile features and a set of transfer function parameters determined via a neural network trained on a set of training images subjected to the image operation. The method further provides for performing the image operation according to the determined transfer function.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other implementations are also described and recited herein.

### BRIEF DESCRIPTION OF THE DRAWINGS

FIG. 1 illustrates an example system for dynamically tailoring an image operation based on the individual tonal profile of each individual image subjected to the image operation.

FIG. 2 illustrates another example system for dynamically tailoring an image operation based on the individual tonal profile of the image subjected to the image operation.

FIG. 3 illustrates example operations for training and application phases of a tone-based image conversion tool.

FIG. 4 illustrates exemplary tonal features usable to classify the tonal profile of an image and select transfer function parameters for a defined image operation.

FIG. 5 illustrates example operations for dynamically tailoring an image operation based on the individual tonal profile of the image subjected to the image operation.

FIG. 6 illustrates an example schematic of a processing device suitable for implementing aspects of the disclosed technology.

### DETAILED DESCRIPTION

Digital effects artists are trained to achieve aesthetic image effects by manipulating physical stylistic features and paying particular attention to the emotional implications that those features provoke. When an artist is trying to achieve a particular aesthetic effect through one or more image operations, such as operations to sharpen, enhance color, or change a pixel domain, the artist is likely to consider the tonal profile of the image. For example, a high dynamic range (HDR) offers much higher levels of contrast than standard dynamic range (SDR), meaning that brightest “whites” are whiter and the darkest “blacks” are blacker in HDR than SDR. When an HDR image having a dark tonal profile is converted for viewing on an SDR device, the image may lose detail if certain pixel colors are not enhanced during the conversion (e.g., because the number of available dark tones in the same pixel range is reduced). In this case as well as a variety of other instances, an artist may choose to dynamically tailor the implementation of the image operation based on a consideration of the image's tonal profile.

Although automated solutions for image conversion commonly implement non-dynamic transfer functions (e.g., tone-mapping) and in limited instances, dynamic alterations based on image recognition of spatial features (e.g., recognized ‘sky’ as a certain pixel value), existing automated solutions lack the capacity to recognize and/or dynamically alter image operations based on a consideration of image features that are not purely spatial. The herein disclosed technology addresses these challenges by adapting machine-learning image-recognition techniques to facilitate the recognition and classification of an image's tonal profile and to dynamically tailor a defined image operation based on the image's tonal profile.

When the tonal profile of an image is used to inform the selection of specific pixel-to-pixel conversions performed as part of an image operation, the final image is more likely to be visually stimulating than the same image operation performed without consideration of the tonal profile. As used herein, the term “image operation” is intended to broadly refer to any image modification operation that alters pixel values including without limitation alterations that are implemented to convert an image for viewing on display devices with different specifications. Example image operations include, without limitation, operations for altering one or more image properties such as image contrast, resolution, luminosity ranges, or stylization (such as by blurring or tilt-shifting). The term image operation may be used herein to refer to operations for achieving a single effect (e.g., burring) or a combination of multiple different effects.

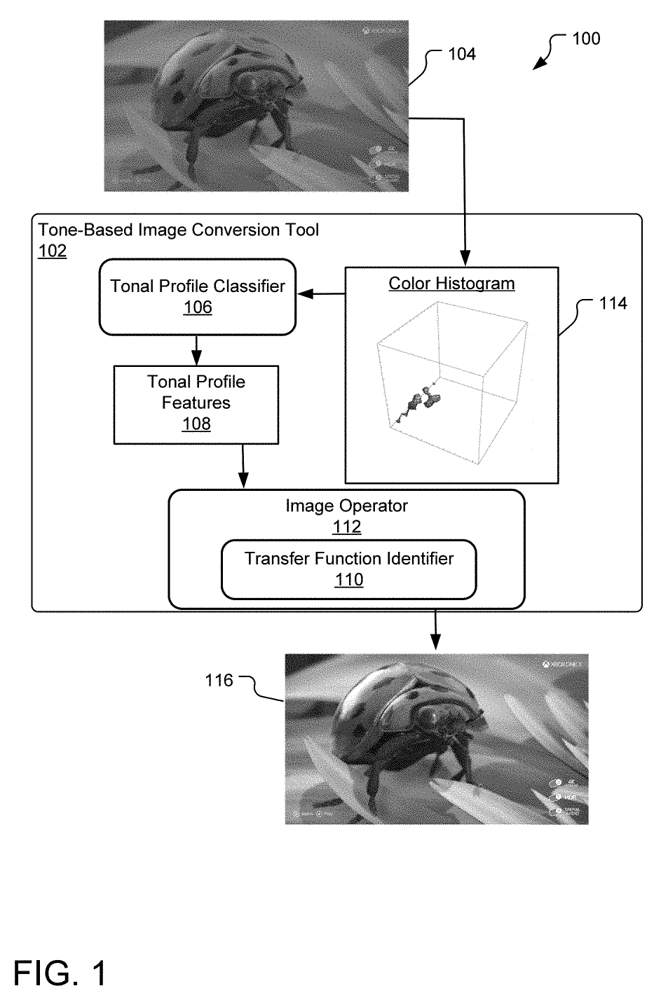

FIG. 1 illustrates an example system 100 for dynamically tailoring an image operation based on the individual tonal profile of each individual image subjected to the image operation. The system 100 includes a tone-based image conversion tool 102 including software and/or a combination of hardware and software. The tone-based image conversion tool 102 receives an image 104 as input and performs a series of operations to convert one or more pixel values of the image 104 according to a defined image operation.

In different implementations, the tone-based image conversion tool 102 may implement a variety of different pre-defined image operations for a variety of different purposes. In one example implementation, the image operation converts the image 104 from a format suitable for display on a first type of display device to another format suitable for display on a second type of display device. For example, the image operation may convert the image 104 to a different pixel resolution, such as from a low definition to a high definition or vice versa. In another implementation, the image operation converts the image from a first contrast range to a second different contrast range, such as between standard dynamic range (SDR) and high dynamic range (HDR) or vice-versa. In still other implementations, the image operation is a stylization change, such as to change the image 104 from a photographic style to a style that is more painted or cartoonish, or instead by blurring, tilt-shifting, sharpening, or performing some other stylistic alteration. In some implementations, the tone-based image conversion tool 102 implements more than one image operation to transform the image 104.

The tone-based image conversion tool 102 implements the image operation based on characteristics of a tonal profile for the image 104. Responsive to receipt of the image 104, the tone-based image conversion tool 102 generates a color histogram 114 representing a tonal profile of the image. In general, the color histogram 114 represents the distribution of colors in the image 104 and particularly, the proportion of the number of different types of colors, regardless of the spatial location of the colors. The color histogram 114 may assume different forms in various implementations including, for example, RGB, rg chromaticity, and other color space of any dimension. In one implementation, the color histogram 114 corresponds to a three-dimensional volume where each “bin” (e.g., square) in the volume represents a color (pixel value) in the RGB color space given by some combination of blue, green, and red.

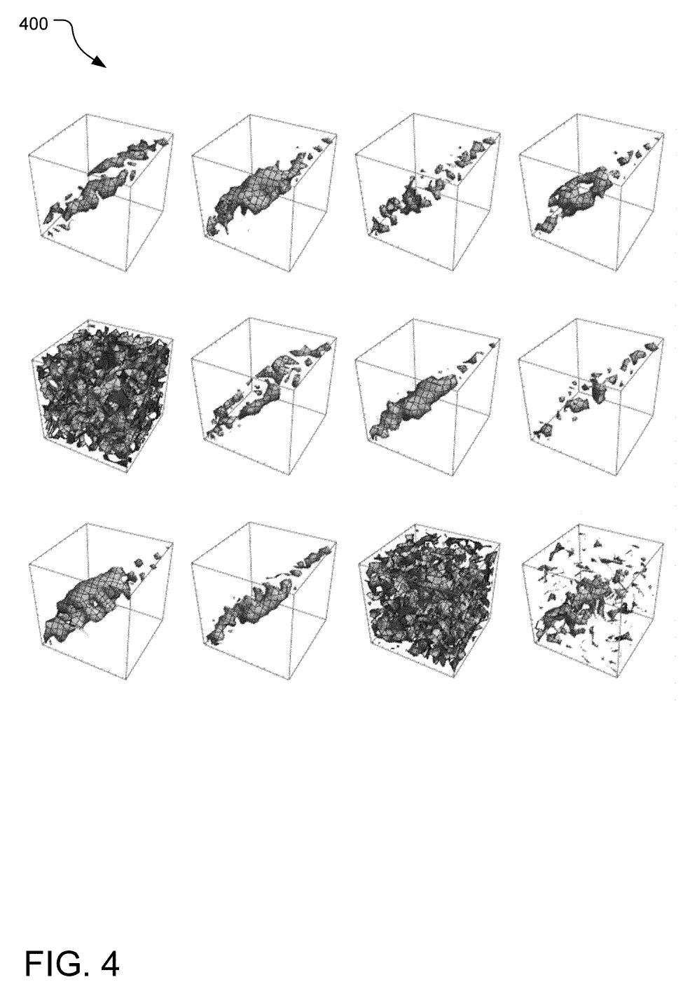

A tonal profile classifier 106 performs operations to analyze the color histogram 114 and to identify one or more tonal profile features 108. In general, the tonal profile features 108 (e.g., tonal feature weights) may be understood as representing principle components of the color histogram 114 and/or the degree to which the color histogram 114 embodies certain predefined tonal features. Tonal features each represent, for example, a percentage of the image that are within a particular color region. A few exemplary tonal profile features are shown and discussed with respect to FIG. 4, below.

The tonal profile classifier 106 implements a machine learning model to classify the tonal profile of the image 104. In different implementations, the machine learning model may implement different learning solutions. The tonal profile classifier 106 may be trained via various techniques for machine learning including, without limitation, supervised learning, unsupervised learning, reinforcement learning, other machine learning techniques or any combination therefore. The various machine learning technique(s) employed by the tonal profile classifier 106 may utilize learning from artificial neural networks of various types including, without limitation, convolutional neural networks, regions with convolutional neural networks (R-CNN), and recurrent neural networks.

The tonal profile classifier 106 evaluates the degree to which each of various tonal features are represented within the color histogram 114 and outputs the tonal profile features 108 for the image 104. In one implementation, the tonal profile classifier 106 performs this evaluation by implementing a neural network that calculates a convolution layer between the color histogram 114 and each of several filters representing different predefined tonal features of interest. Here, the tonal profile features 108 output by the tonal profile classifier 106 are weightings computed during the convolution, and the tonal profile features 108 indicate the relative similarity between the color histogram 114 and each of the filters.

In lieu of computing a convolution layer, the tonal profile classifier 106 may, in other implementations, utilize other types of machine learning to determine the tonal profile features 108 of the color histogram 114.

The tonal profile classifier 106 provides the identified tonal profile features 108 to an image operator 112. The image operator 112 includes a transfer function identifier 110 that determines parameters for implementing the defined image operation using the parameters determined by the transfer function identifier 110 and the tonal profile features 108, the image operator 112 determines a transfer function for performing the defined image operation. As used herein, a transfer function is a relationship usable to determine how various pixel values of the image 104 are altered by a particular image operation. Stated differently, a transfer function is usable to execute an image operation by providing an output pixel value corresponding to each pixel value of the image 104. In one implementation, a transfer function defines a transformation between one color space and another color space, such as to convert an image formatted for viewing on a first device with a first color space into a format suitable for viewing on a second device with a second color space.

The image operator 112 performs the defined image operation and replaces each of multiple pixels in the image 104 with a corresponding transformed pixel value determined by the transfer function. After the image operator 112 performs the image operation, the tone-based image conversion tool 102 outputs a transformed image 116 resulting from application of the transfer function to the image 104. In one implementation, the transformed image 116 is of a format (e.g., resolution, contrast) suitable for presentation on a display device with different specifications than a display device suitable for presenting the image 104. In one implementation, the image 104 and the transformed image 116 represent different resolutions (e.g., a conversion from high to low or vice versa). In another implementation, the image 104 and the transformed image 116 represent different contrast ranges (e.g., SDR to HDR or vice versa).

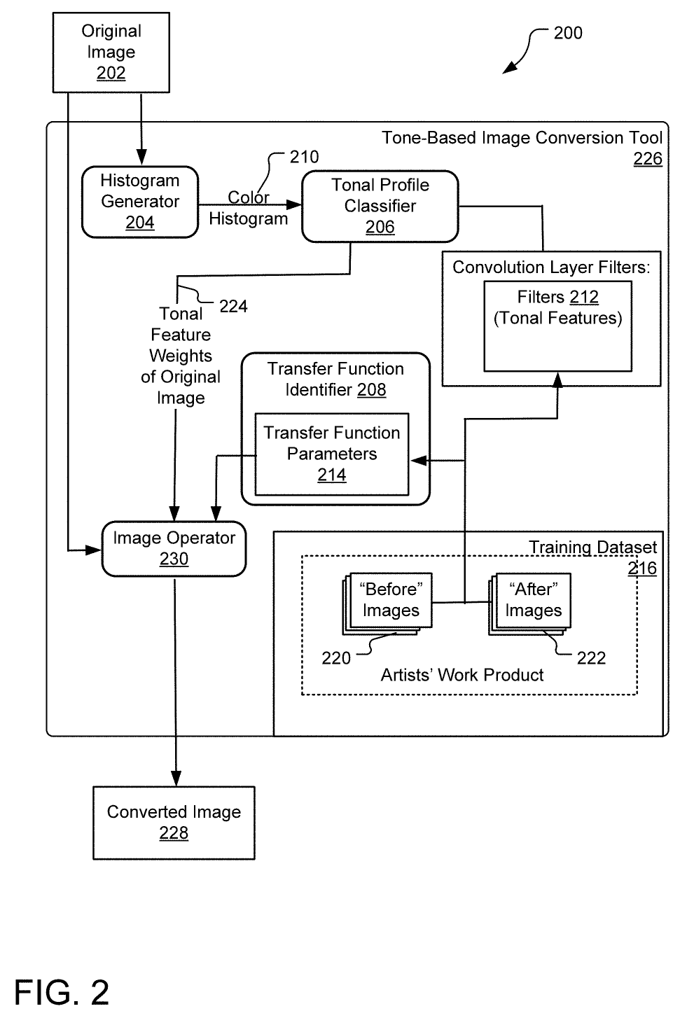

FIG. 2 illustrates another example system 200 for dynamically tailoring an image operation based on the individual tonal profile of the image subjected to the image operation. The system 200 includes a tone-based image conversion tool 226, including software and/or a combination of hardware and software. The tone-based image conversion tool 226 receives an original image 202 as input and performs operations to alter pixels of the original image 202 to execute a defined image operation. The specific manner in which the pixels are altered is dynamically determined by the tone-based image conversion tool 226 based on an analysis of the tonal profile of the original image 202.

Responsive to receipt of the original image 204, the tone-based image conversion tool 226 generates a color histogram 210 representing a tonal profile of the original image 202. Various aspects of the color histogram 210 may be the same or similar as those traits described with respect to FIG. 1, above.

A tonal profile classifier 206 receives the color histogram 210 as input and executes image-recognition logic to analyze the color histogram 210 and to determine a similarity between the color histogram 210 and each of multiple tonal profile features. In FIG. 2, the tonal profile classifier 206 implements a convolution layer to compute weights for the original image 202 corresponding to each of multiple filters 212, representing various tonal profile features. In one implementation, each of the different filters 212 is an array the same size as the color histogram 210, such as an array that is 8×8×8 or 16×16×16.

Each of the filters 212 is a color histogram representing a defined combination of tones, such as a particular collection of dark color tones, bright color tones, warm color tones, etc. In addition to representing the tonal areas, the filters 212 can also include negative values that allow for the detection of the absence of certain tones in the presence of other tones. A few example filters representing predefined tonal features of interest are shown and described below with respect to FIG. 4.

In one implementation, the tonal profile features represented by the filters 212 are defined during an initial training phase of a neural network, during which the tone-based image conversion tool 226 is provided with a training dataset 216 including a collection of image pairs (e.g., including before images 220 and corresponding after images 222), where the before images 220 and after images 222 of each pair represent before and after effects of the image operation that the tone-based image conversion tool 226 is designed to implement. These pairs are referred to below as “before/after image pairs.” In one implementation, each of the before/after image pairs 220, 222 represent before/after work product of an artist, such as a digital effects artist, that performs the image operation on the “before” image 220 of the before/after image pair 220, 222 by effecting pixel value alterations based on the tonal profile of the individual image, such as with the intent of ensuring image details are not muted or lost during the image operation. For example, the before/after image pairs 220, 222 may be HDR/SDR image pairs, where an artist has converted each HDR image of the before images 220 into a corresponding SDR image of the after images 222 based on considerations of the tonal profile of the HDR image.

An HDR-to-SDR conversion represents just one of multiple types of image operations that the tone-based image conversion tool 226 may be designed to implement. In other implementations, the image operation implemented by the tone-based image conversion tool 226 effects a different type of image operation, such as SDR-to-HDR conversion, a resolution conversion, a stylistic conversion, etc.

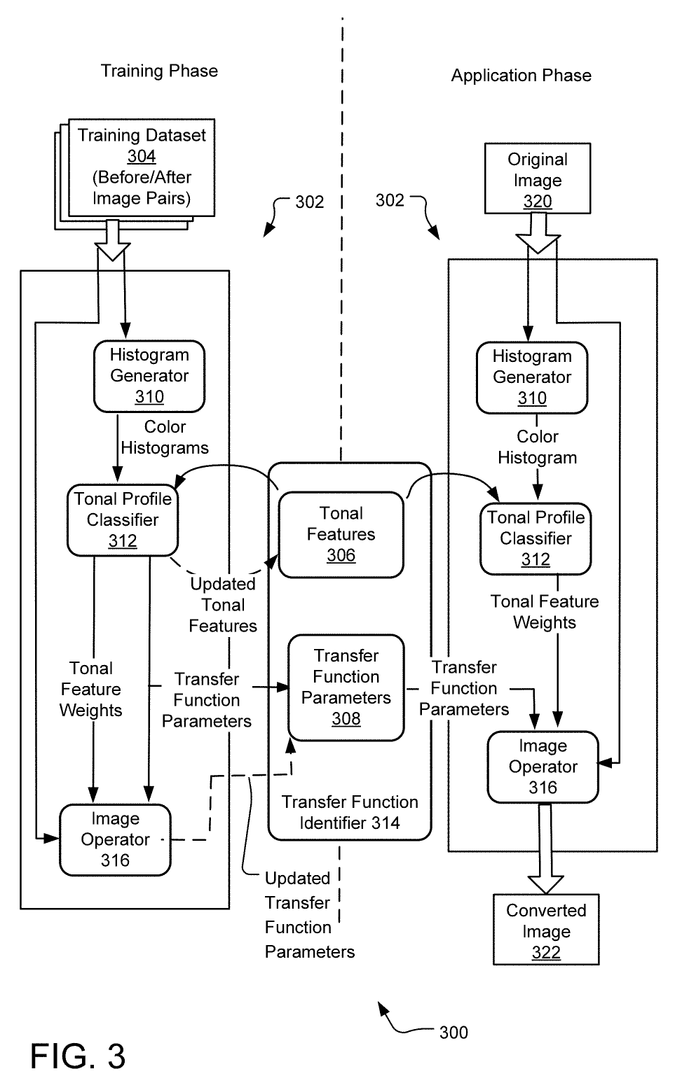

In the training process used for determining the tonal profile features represented by the filters 212, the tone-based image conversion tool 226 analyzes each of the before/after image pairs 220,222 in association with their corresponding histograms. From this analysis, the tone-based image conversion tool 226 determines transfer function parameters usable to transform the “before” image 220 of each of the before/after image pairs 220, 222 into the corresponding “after” image 222. Throughout training, a transfer function identifier 208 refines its understanding of how different tonal profile features correlate with different transfer function parameters, eventually deriving a set of transfer function parameters 214 and tonal profile features for the filters 212 that are used in the illustrated application phase (post-training). Further example details pertaining to the training of the tone-based image conversion tool 226 are discussed with respect to FIG. 3, below.

During analysis of the original image 202 (in the post-training, application phase), the tonal profile classifier 206 computes a convolution layer between the filters 212 and the color histogram 210 and determines a number of tonal feature weights 224. The tonal feature weights 224 numerically represent the mathematically-determined similarity between the color histogram 210 and the tonal profile features represented by the filters 212. The tonal profile classifier 206 outputs the tonal feature weights 224 of the original image 202 and provides these weights as inputs to an image operator 230.

In addition to receiving the tonal feature weights 224 of the original image 202, the image operator 230 is also provided with the set transfer function parameters 214 determined during training. The image operator 230 uses this information to determine a particular transfer function that is usable to determine how each pixel of the original image 202 is altered by the image operation that the tone-based image conversion tool 226 is designed to implement. The image operator 230 executes the transfer function on the original image 202 and the tone-based image conversion tool 226 outputs a converted image 228. As discussed above with respect to FIG. 1, the use of tonal profile features to determine a transfer function for the image operation causes the resulting converted image 228 to retain more detail (e.g., between similar color tones) and appear of generally higher quality to a user than that resulting from an image operation that is based on strict tone-mapping of one pixel color to another.

FIG. 3 illustrates other example operations 300 for training and application phases of a tone-based image conversion tool 302. During a training phase (shown at left), the tone-based image conversion tool 302 is trained on a series of before/after image pairs included in a training dataset 304. Throughout this training, the tone-based image conversion tool 302 refines a set of determined correlations between different transfer function parameters and tonal profile features extracted from the training dataset 304, which is in one implementation the same or similar to the training dataset 216 described above with respect to FIG. 2.

During the illustrated training phase, a histogram generator 310 is provided with several (e.g., thousands) of pairs of images. Each image pair includes a “before image” and a corresponding “after image,” where the before and after images of each pair represent before and after effects of the image operation that the tone-based image conversion tool 302 is designed to implement.

For each received before/after image pair, the histogram generator 310 generates color histograms corresponding to the before image of the pair. The color histograms are provided to a tonal profile classifier 312, which uses a convolution of the color histogram (e.g., a normalized 3d histogram) to teach a neural network how the image operation (e.g., the conversion between the before/after pairs) varies with the tonal profile of an image.

Upon receipt of the color histograms corresponding to each new before/after training data pair of the training dataset 304, the tonal profile classifier 312 compares the color histograms to a set of tonal features 306 and determines corresponding transfer function parameters 308 for converting the before image into the corresponding tonal features of the after image. Based on the determined transfer function parameters 308, the tonal profile classifier 312 updates the set of tonal features 306 for use in analyzing the next received before/after image pair. Initially, the tonal features 306 are, for example, arrays initially set to random values that are mathematically refined as the tonal feature classifier 312 begins to detect repeated patterns of similar tonal features.

In addition to updating the set of tonal features 306 and identifying transfer function parameters, the tonal profile classifier 312 computes tonal feature weights representing a degree of similarity between color histograms and each feature of the current set of tonal features 306 (which changes throughout the training). The computed tonal feature weights and transfer function parameters are provided to an image operator 316, which in turn refines the transfer function parameters 308 based on the computed tonal feature weights. These refined transfer function parameters 308 are provided to back the transfer function identifier 314, which stores the transfer function parameters 308 until they are refined again during the training phase or used during the application phase (shown at right in FIG. 3).

At the conclusion of the training phase, the transfer function identifier 314 stores a final, refined set of the tonal features 306 and a final, refined set of the transfer function parameters 308, each representing a correlation between at least one tonal feature and the before/after phases of the image operation. This final set of the transfer function parameters 308 is provided to the image operator 316 for use during the application phase. Using this set of transfer function parameters 314, the image operator 316 can, during a non-training operation, compute a transfer function for any input set of tonal feature weights, even if the specific permutation of tonal feature weights has not been observed in any of the training images. This computed transfer function is then usable to transform an input image in a manner that mimics an artist-rendered image operation performed with a specific consideration of the image's tonal profile.

During an application phase (after training is completed), the tone-based image conversion tool 302 receives as input an original image 320 to be subjected to the image operation. The histogram generator 310 generates a color histogram corresponding to the original image 320, and the tonal profile classifier 312 computes tonal feature weights based on the final, refined set of the tonal features 306. The image operator 316 identifies applicable transfer function parameters (from the final, refined set of the transfer function parameters 308) and uses the identified transfer function parameters 308 in conjunction with the tonal feature weights to determine the transfer function. The image operator 316 applies the transfer function to the original image 320 to perform the image operation, ultimately outputting converted image 322.

FIG. 4 illustrates exemplary set of tonal features 400 usable to classify the tonal profile and compute tonal feature weights during an application phase of a tone-based image conversion tool. Each of the predefined tonal features 400 is shown as a three-dimensional volume plotted in three-dimensional space. In one implementation, the three axes represent reds, greens, and blues of the RGB color space. Each bin (square) in the volume represents a particular color within the image and the amount of the color in the image is represented by the number of pixels falling within each bin. In FIG. 4, the different relative intensities of the different colors in the image is represented by different greyscale shades.

Mathematically, each of the predefined tonal features 400 can be defined as an array, such as with different array columns for each of Red, Green, Blue, and “total bin pixel count” and different array rows representing the various combinations of Red, Green, and Blue (e.g., 0 to 255 for each color on some displays) contributing to each of the different colors representable by a computer display. Each individual one of the predefined tonal features 300 conveys information about the tonal profile.

In one implementation, a tonal profile classifier, such as the tonal profile classifier 206 and 312 of FIGS. 2 and 3, is trained to measure a correlation between a color histogram (e.g., the color histogram 210 of FIG. 2 or 114 of FIG. 1) for an input image and each one of the predefined tonal features 400. For example, arrays representing each one of the predefined tonal features 400 are used as filters from which a convolution layer is computed. In one implementation, the array size of each filter is of a same scale/size as the input image and the convolution is therefore computed over the entire histogram without moving the filter.

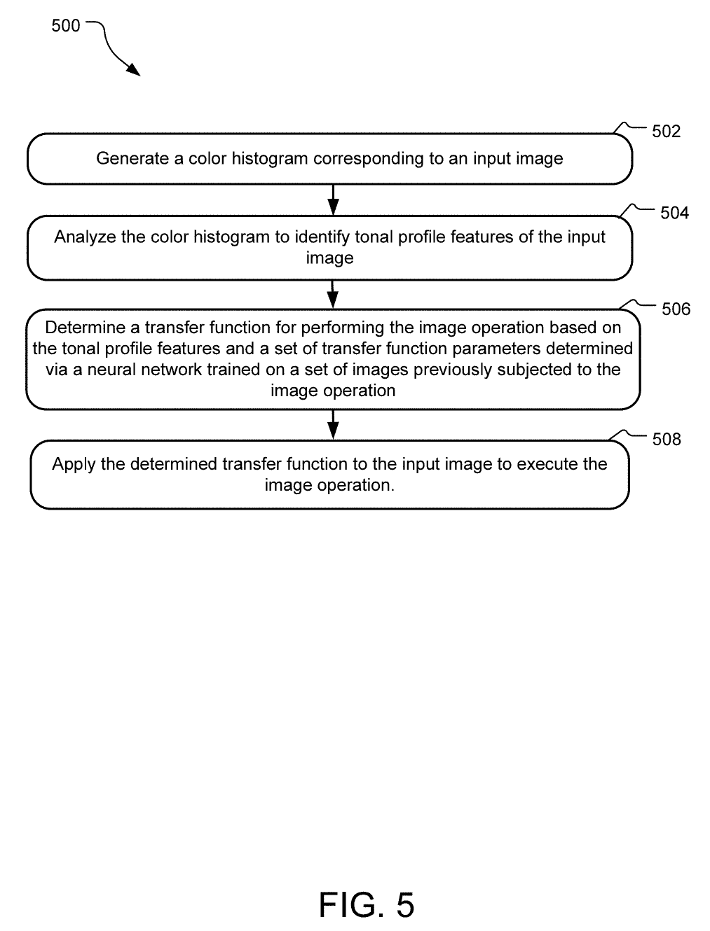

FIG. 5 illustrates example operations 500 for dynamically tailoring an image operation based on the individual tonal profile of the image subjected to the image operation. A histogram generation operation 502 generates a color histogram corresponding to an input image. An analyzing operation 504 analyzes the color histogram to identify tonal profile features of the input image. In one implementation, the analyzing operation 504 computes a similarity between the histogram and each of a number of predefined tonal features by calculating a convolution between the histogram and a number of filters representing the different tonal features. For example, the identified tonal profile features may include weightings representing a strength of each of the predefined tonal features within the input image.

A determining operation 506 determines a transfer function for performing the image operation based on the tonal profile features (e.g., tonal feature weights) and a set of transfer function parameters determined by a neural network training based on a set of training images previously subjected to the image operation. For example, the set of training images includes sets of before/after images representing before and after phases of the same image subjected to an artist's implementation of the image operation. An image conversion operation 508 applies the determined transfer function to the input image to execute the image operation.

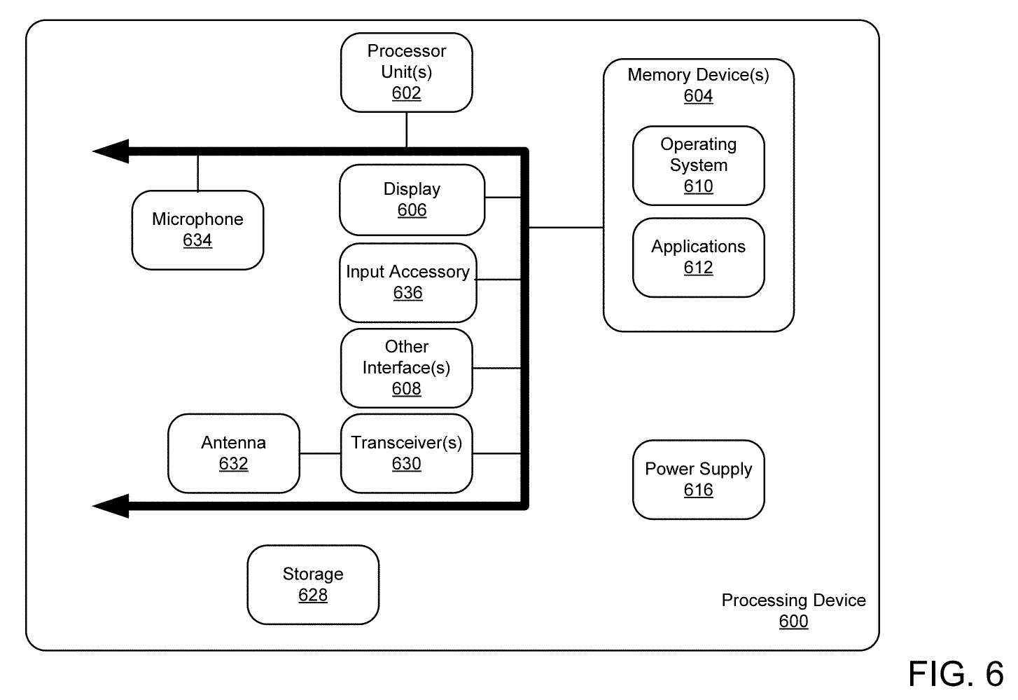

FIG. 6 illustrates an example schematic of a processing device 600 suitable for implementing aspects of the disclosed technology. The processing device 600 includes one or more processor unit(s) 602, memory 604, a display 606, and other interfaces 608 (e.g., buttons). The memory 604 generally includes both volatile memory (e.g., RAM) and non-volatile memory (e.g., flash memory). An operating system 610, such as the Microsoft Windows® operating system, the Microsoft Windows® Phone operating system or a specific operating system designed for a gaming device, resides in the memory 604 and is executed by the processor unit(s) 602, although it should be understood that other operating systems may be employed.

One or more applications 612, such as a tone-based image conversion tool (e.g., the tone-based image conversion tools 102 in FIGS. 1 and 226 in FIG. 2) are loaded in the memory 604 and executed on the operating system 610 by the processor unit(s) 602. The applications 612 may receive input from various input devices such as a microphone 634 or input accessory 636 (e.g., keypad, mouse, stylus, touchpad, gamepad, racing wheel, joystick). The processing device 600 includes a power supply 616, which is powered by one or more batteries or other power sources and which provides power to other components of the processing device 600. The power supply 616 may also be connected to an external power source that overrides or recharges the built-in batteries or other power sources.

The processing device 600 includes one or more communication transceivers 630 and an antenna 632 which may provide network connectivity (e.g., a mobile phone network, Wi-Fi®, Bluetooth®). The processing device 600 may also include various other components, such as a positioning system (e.g., a global positioning satellite transceiver), one or more accelerometers, one or more cameras, an audio interface (e.g., a microphone 634, an audio amplifier and speaker and/or audio jack), and storage devices 628. Other configurations may also be employed.

In an example implementation, a mobile operating system, various applications (e.g., a tonal profile and/or tone-based image conversion tool) and other modules and services may have hardware and/or software embodied by instructions stored in memory 604 and/or storage devices 628 and processed by the processor unit(s) 602. The memory 604 may be memory of host device or of an accessory that couples to a host.

The processing device 600 may include a variety of tangible computer-readable storage media and intangible computer-readable communication signals. Tangible computer-readable storage can be embodied by any available media that can be accessed by the processing device 600 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

An example method for dynamically tailoring an image operation based on tonal profile features of an input image includes identifying the tonal profile features of the input image; determining a transfer function for performing the image operation, the determined transfer function based on the tonal profile features and transfer function parameters determined by a neural network trained on a set of training images subjected to the image operation; and performing the image operation according to the determined transfer function.

In an example method of any preceding method, identifying the tonal profile features of the input image further includes calculating a convolution between a color histogram corresponding to the input image and a series of filters representing tonal features defined during training of the neural network.

In another example method of any preceding method, each filter of the series of filters is of a same array size as the color histogram.

In still another example method of any preceding method, the set of training images includes image pairs, each one of the image pairs including images representing before and after stages of the image operation.

In yet another example method of any preceding method, the transfer function parameters represent a determined correlation between one or more tonal features and a conversion of one or more pixel values during the image operation.

In another example method of any preceding method, the image operation alters a luminosity range of the input image.

In still another example method of any preceding method, the image operation includes an operation for at least one of adjusting contrast or stylization.

An example system for dynamically tailoring an image operation based on tonal profile features of an input image includes a tonal profile classifier and an image operator stored in memory. The tonal profile classifier is executable to identify the tonal profile features of the input image, and the image operator is executable to determine a transfer function for performing the image operation and perform the image operation according to the determined transfer function. The transfer function is based on the tonal profile features and transfer function parameters determined by a neural network trained on a set of training images subjected to the image operation.

In one example system of any preceding system, the set of training images includes image pairs, each one of the image pairs including images representing before and after stages of the image operation.

In another example system of any preceding system, the transfer function parameters represent a determined correlation between one or more tonal features and a conversion of one or more pixel values during the image operation.

In still another example system of any preceding system, the tonal profile classifier is further executable to identify the tonal profile features of the input image by calculating a convolution between a color histogram corresponding to the input image and a series of filters representing tonal profile features.

In another example system of any preceding system, each filter of the series of filters is of a same array size as the color histogram.

In still another example system of any preceding system, the image operation alters a luminosity range of the input image.

In yet another example system of any preceding system, the image operation includes an operation for at least one of adjusting contrast or stylization.

An example tangible computer-readable storage media encodes computer-executable instructions for executing on a computer system a computer process for dynamically tailoring an image operation based on tonal profile features of an input image. The example computer process comprises identifying the tonal profile features of the input image and determining a transfer function for performing the image operation. The determined transfer function is based on the tonal profile features and transfer function parameters determined by a neural network training on a set of training images subjected to the image operation. The example computer process further comprises performing the image operation according to the determined transfer function.

In one example computer process of any preceding computer process, the set of training images includes image pairs and each one of the image pairs includes images representing before and after stages of the image operation.

In another example computer process of any preceding computer process, the transfer function parameters represent a determined correlation between one or more tonal features and a conversion of one or more pixel values during the image operation.

In yet another example computer process of any preceding computer process, identifying the tonal profile features of the input image further includes calculating a convolution between a color histogram corresponding to the input image and a series of filters representing tonal profile features defined during training of the neural network.

In still another example computer process of any preceding computer process, the image operation alters a luminosity range of the input image.

In still another example computer process of any preceding computer process, the image operation includes an operation for at least one of adjusting image contrast or stylization.

An example system for dynamically tailoring an image operation based on tonal profile features of an input image includes a means for identifying the tonal profile features of the input image; a means for determining a transfer function for performing the image operation, the determined transfer function based on the tonal profile features and transfer function parameters determined by a neural network trained on a set of training images subjected to the image operation; and a means for performing the image operation according to the determined transfer function.

The above specification, examples, and data provide a complete description of the structure and use of exemplary implementations. Since many implementations can be made without departing from the spirit and scope of the claimed invention, the claims hereinafter appended define the invention. Furthermore, structural features of the different examples may be combined in yet another implementation without departing from the recited claims.

What is claimed is:

1. A method for dynamically tailoring an image operation based on tonal profile features of an input image, the method comprising:
identifying the tonal profile features of the input image;
determining a transfer function for performing the image operation, the determined transfer function based on the tonal profile features and transfer function parameters determined by a neural network trained on a set of training images subjected to the image operation; and
performing the image operation according to the determined transfer function.

2. The method of claim 1, wherein identifying the tonal profile features of the input image further includes:
calculating a convolution between a color histogram corresponding to the input image and a series of filters representing tonal features defined during training of the neural network.

3. The method of claim 2, wherein each filter of the series of filters is of a same array size as the color histogram.

4. The method of claim 1, wherein the set of training images includes image pairs, each one of the image pairs including images representing before and after stages of the image operation.

5. The method of claim 3, wherein the transfer function parameters represent a determined correlation between one or more tonal features and a conversion of one or more pixel values during the image operation.

6. The method of claim 1, wherein the image operation alters a luminosity range of the input image.

7. The method of claim 1, wherein the image operation includes an operation for at least one of adjusting contrast or stylization.

8. A system for dynamically tailoring an image operation based on tonal profile features of an input image, the system comprising:
memory;
a processor;
a tonal profile classifier stored in the memory and executable by the processor to identify the tonal profile features of the input image; and
an image operator stored in the memory and executable by the processor to:
determine a transfer function for performing the image operation, the transfer function based on the tonal profile features and transfer function parameters determined by a neural network trained on a set of training images subjected to the image operation; and
perform the image operation according to the determined transfer function.

9. The system of claim 8, wherein the set of training images includes image pairs, each one of the image pairs including images representing before and after stages of the image operation.

10. The system of claim 8, wherein the transfer function parameters represent a determined correlation between one or more tonal features and a conversion of one or more pixel values during the image operation.

11. The system of claim 8, wherein the tonal profile classifier is further executable to identify the tonal profile features of the input image by:
calculating a convolution between a color histogram corresponding to the input image and a series of filters representing tonal profile features.

12. The system of claim 11, wherein each filter of the series of filters is of a same array size as the color histogram.

13. The system of claim 8, wherein the image operation alters a luminosity range of the input image.

14. The system of claim 8, wherein the image operation includes an operation for at least one of adjusting contrast or stylization.

15. One or more tangible computer-readable storage media encoding computer-executable instructions for executing on a computer system a computer process for dynamically tailoring an image operation based on tonal profile features of an input image, the computer process comprising:
identifying the tonal profile features of the input image;
determining a transfer function for performing the image operation, the determined transfer function based on the tonal profile features and transfer function parameters determined by a neural network training on a set of training images subjected to the image operation; and
performing the image operation according to the determined transfer function.

16. The one or more computer-readable storage media of claim 15, wherein the set of training images includes image pairs, each one of the image pairs including images representing before and after stages of the image operation.

17. The one or more computer-readable storage media of claim 15, wherein the transfer function parameters represent a determined correlation between one or more tonal features and a conversion of one or more pixel values during the image operation.

18. The one or more computer-readable storage media of claim 15, wherein identifying the tonal profile features of the input image further includes:
calculating a convolution between a color histogram corresponding to the input image and a series of filters representing tonal profile features defined during training of the neural network.

19. The one or more computer-readable storage media of claim 15, wherein the image operation alters a luminosity range of the input image.

20. The one or more computer-readable storage media of claim 15, wherein the image operation includes an operation for at least one of adjusting image contrast or stylization.
